(19) United States
(12) Patent Application Publication
(10) Pub. No.: US 2005/0086780 A1
(43) Pub. Date: Apr. 28, 2005

(54) Method of fabricating circular or angular spiral MIM capacitors

(75) Inventors: Kai Shao, Shanghai (CN); Chit Hwei Ng, Singapore (SG); Purakh Raj Verma, Singapore (SG); Jia Zhen Zheng, Singapore (SG); Sanford Chu, Singapore (SG)

Correspondence Address: STEPHEN B. ACKERMAN, 28 DAVIS AVENUE, POUGHKEEPSIE, NY, 12603, US

(73) Assignee: Chartered Semiconductor Manufacturing Ltd.

(21) Appl. No.: 10/692,029

(22) Filed: Oct. 23, 2003

(51) Int. Cl. H01G 7/00; H01K 3/10

(52) U.S. Cl. 29/25.41; 29/25.42; 29/852

(57) ABSTRACT

A method of forming a capacitor comprising the following steps. A substrate having a lower low-k dielectric layer formed thereover is provided with the lower low-k dielectric layer having a dielectric constant of less than about 3.0. Metal vertical electrode plates are formed within the lower low-k dielectric layer so that the adjacent metal vertical electrode plates have lower low-k dielectric layer portions therebetween. The lower low-k dielectric layer portions between the adjacent metal vertical electrode plates are replaced with high-k dielectric material trench portions having a dielectric constant of greater than about 3.0.

### FIELD OF THE INVENTION

The present invention relates generally to fabrication of semiconductor devices, and more specifically to methods of fabricating metal-insulator-metal (MIM) capacitors.

### BACKGROUND OF THE INVENTION

Circular or angular spiral metal-insulator-metal (MIM) capacitors are useful semiconductor devices.

U.S. Pat. No. 6,309,922 B1 to Liu et al. describes a spiral inductor process.

U.S. Pat. No. 6,274,502 B1 to Ohkuni describes a circular inductor process.

U.S. Pat. No. 6,258,652 B1 to Stacey describes a spiral inductor process having air gaps.

U.S. Pat. No. 6,054,329 to Burghartz et al. describes another spiral inductor process.

### SUMMARY OF THE INVENTION

Accordingly, it is an object of the present invention to provide improved methods of forming a circular or angular spiral metal-insulator-metal (MIM) capacitors.

Other objects will appear hereinafter.

It has now been discovered that the above and other objects of the present invention may be accomplished in the following manner. Specifically, substrate having a lower low-k dielectric layer formed thereover is provided with the lower low-k dielectric layer having a dielectric constant of less than about 3.0. Metal vertical electrode plates are formed within the lower low-k dielectric layer so that the adjacent metal vertical electrode plates have lower low-k dielectric layer portions therebetween. The lower low-k dielectric layer portions between the adjacent metal vertical electrode plates are replaced with high-k dielectric material trench portions having a dielectric constant of greater than about 3.0.

### BRIEF DESCRIPTION OF THE DRAWINGS

The features and advantages of the present invention will be more clearly understood from the following description taken in conjunction with the accompanying drawings in which like reference numerals designate similar or corresponding elements, regions and portions and in which:

FIG. 1 is a top down plan view of an angular spiral MIM capacitor made in accordance with the present invention.

FIG. 2 is a top down plan view of a circular MIM capacitor made in accordance with the present invention.

FIGS. 3 to 9 schematically illustrate in cross-sectional representation a preferred embodiment of the present invention with FIG. 9 being the cross-sectional view along line 9-9 of FIG. 1 or line 9-9 of FIG. 2.

### DETAILED DESCRIPTION OF THE PREFERRED EMBODIMENTS

For the purposes of this invention, a low-k dielectric material has a dielectric constant of less than about 3.0 and a high-k dielectric material has a dielectric constant of preferably greater than about 3.0 and more preferably from about 7.0 to 50.0.

FIG. 1 is a top down, plan view of an angular spiral MIM capacitor 10′ made in accordance with the present invention. Spiral MIM capacitor 10′ includes a spiral metal portion 12′ with high-k dielectric material 14′ between adjacent portions 16′, 18′, 20′, 22′, 24′, 26′ as shown along line 9-9, for example. Spiral MIM capacitor 10′ is surrounded by a low-k dielectric material 30′. FIG. 1 also illustrates another metal structure 32′ proximate the angular spiral MIM capacitor 10′.

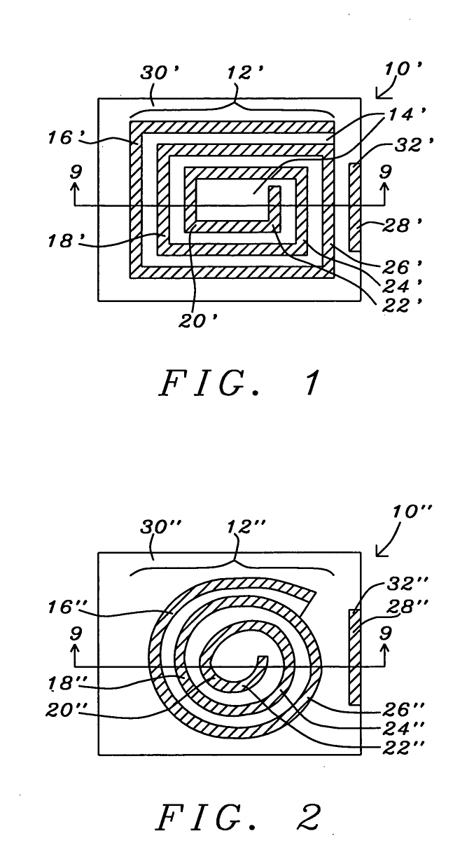

FIG. 2 is a top down, plan view of a circular MIM capacitor 10″ made in accordance with the present invention. Circular MIM capacitor 10″ includes a circular metal portion 12″ with high-k dielectric material 14″ between adjacent portions 16″, 18″, 20″, 22″, 24″, 26″ as shown along line 9-9, for example. Spiral MIM capacitor 10″ is surrounded by a low-k dielectric material 30″. FIG. 2 also illustrates another metal structure 32″ proximate the circular MIM capacitor 10″.

Regardless of whether an angular spiral MIM capacitor 10′ or a circular MIM capacitor 10″ is to be formed, the following description of the method of the present invention applies to the fabrication of each MIM capacitor 10′, 10″. For ease of understanding, the corresponding structures of angular spiral MIM capacitor 10′ and circular MIM capacitor 10″ will be illustrated without a prime suffix. That is, e.g., angular spiral MIM capacitor 10′ and circular MIM capacitor 10″ will both be annotated as MIM capacitor 10.

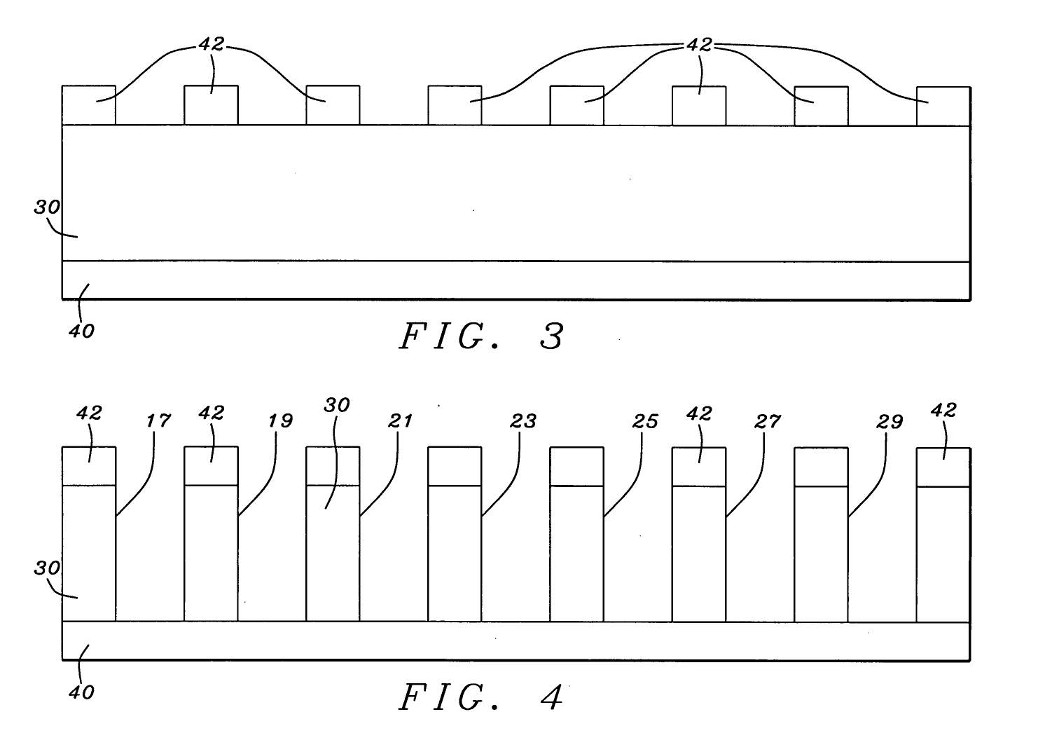

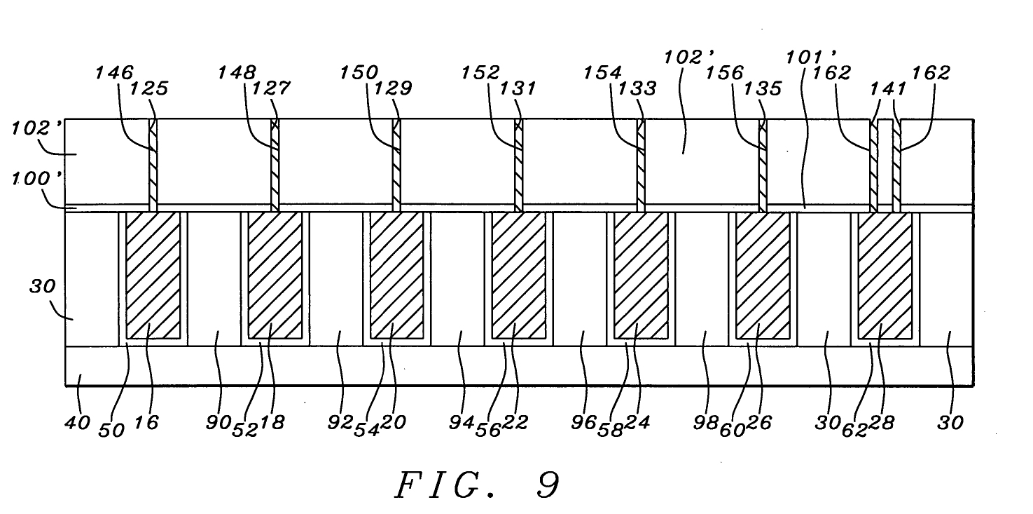

FIGS. 3 to 9 schematically illustrate in cross-sectional representation a preferred embodiment of the present invention with FIG. 9 being the cross-sectional view along line 9-9 of FIG. 1 or line 9-9 of FIG. 2.

It is noted that while six adjacent portions 16′, 18′, 20′, 22′, 24′, 26′ for a spiral MIM capacitor 10′ and six adjacent portions 16″, 18″, 20″, 22″, 24″, 26″ for a circular MIM capacitor 10″ are shown being formed in FIGS. 3 to 9, one skilled in the art recognizes that less or more such respective adjacent portions may be formed depending upon the final spiral MIM capacitor 10′ or circular MIM capacitor 10″ desired to be fabricated.

Initial Structure—FIG. 3

FIG. 3 illustrates a cross-sectional view of a structure 40 having a low-k dielectric material layer 30 formed thereover to a thickness of preferably from about 2000 to 50,000 Å and more preferably from about 5000 to 10,000 Å.

Structure 40 is understood to possibly include a semiconductor wafer or substrate, active and passive devices formed within the wafer, conductive layers and dielectric layers (e.g., inter-poly oxide (IPO), intermetal dielectric (IMD), etc.) formed over the wafer surface. The term “semiconductor structure” is meant to include devices formed within a semiconductor wafer and the layers overlying the wafer.

Low-k dielectric material layer 30 is preferably comprised of TEOS, FTEOS, Coral™, Black Diamond™ or an organic material and is more preferably comprised of an organic material.

A first patterned mask layer 42 is formed over the low-k dielectric material layer 30 to define the capacitor 10 vertical electrode plates 16, 18, 20, 22, 24, 26.

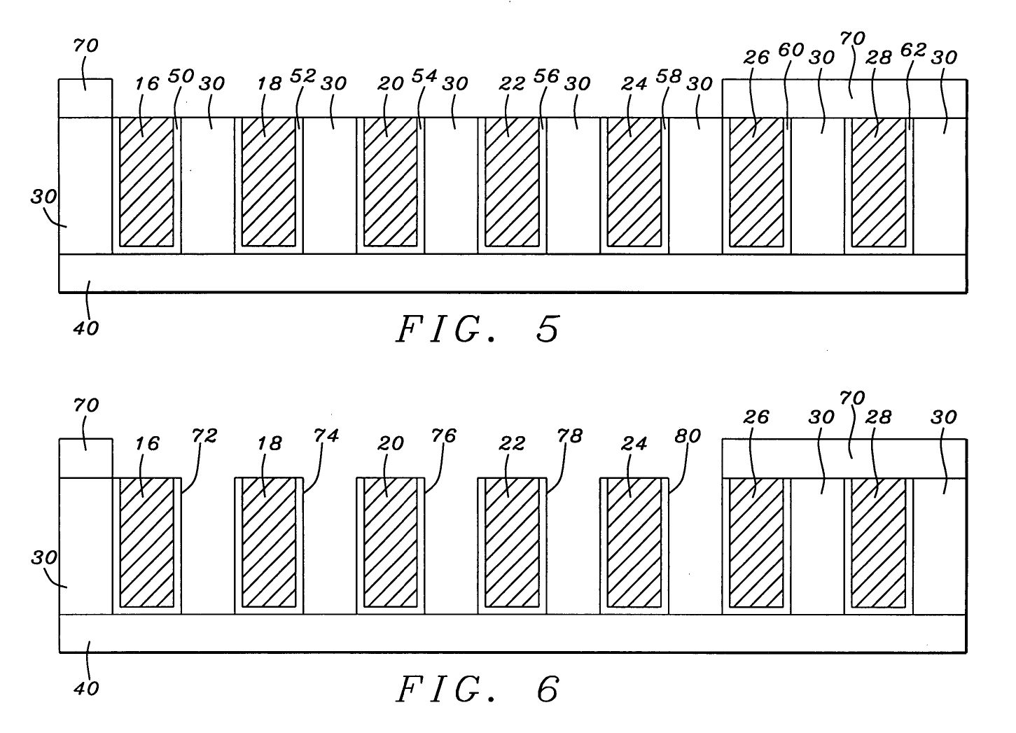

Formation of Vertical Electrode Plate Openings 17, 19, 21, 23, 25, 27—FIG. 4

As shown in FIG. 4, the low-k dielectric material layer 30 is patterned using the first patterned mask layer 42 to form vertical electrode plate openings/trenches 17, 19, 21, 23, 25, 27. Trenches 17, 19, 21, 23, 25, 27 have a width of preferably from about 100 to 50,000 Å and more preferably from about 5,000 to 10,000 Å. (As noted above, trenches 17, 19, 21, 23, 25, 27 may comprise trenches for an angular spiral MIM capacitor 10′ or a circular MIM capacitor 10″.) Trenches 17, 19, 21, 23, 25, 27 are preferably formed concomitantly with logic metal vias or trenches. For example, another opening 29 proximate the to be formed capacitor 10 may also be formed concomitantly with trenches 17, 19, 21, 23, 25, 27 as shown in FIG. 4. It is noted that opening 29 and the metal trench structure 28 formed therein is optional.

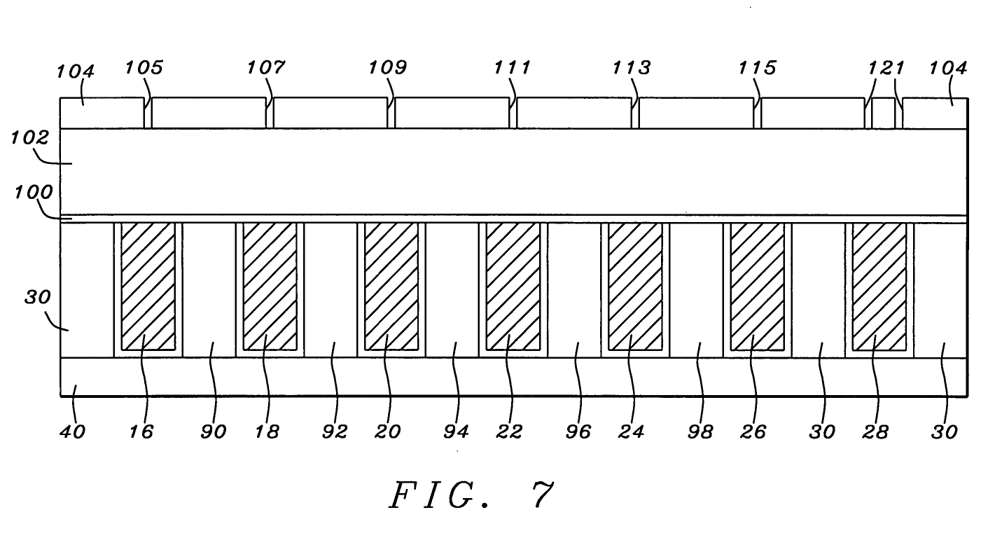

Formation of Metal Vertical Electrode Plates 16, 18, 20, 22, 24, 26 And Metal Trench Structure 28—FIG. 5

As shown in FIG. 5, the first patterned mask layer 42 is removed from the structure of FIG. 4 and the structure may be cleaned as necessary.

Trenches 17, 19, 21, 23, 25, 27 and proximate trench 29 are preferably lined with respective metal barrier layers 50, 52, 54, 56, 58, 60, 62 and are filled with respective planarized metal vertical electrode plate structures 16, 18, 20, 22, 24, 26 and metal trench structure 28.

Metal vertical electrode plate structures 16, 18, 20, 22, 24, 26 and proximate metal structure 28 are preferably comprised of copper (Cu) or tungsten (W) and are more preferably copper (Cu). Metal barrier layers 50, 52, 54, 56, 58, 60, 62 are preferably comprised of Ta or TaN and are more preferably Ta/TaN.

A second patterned mask layer 70 is then formed over patterned low-k dielectric material layer 30 to leave the portions of patterned low-k dielectric material layer 30 between the metal vertical electrode plate structures 16, 18, 20, 22, 24, 26 exposed as shown in FIG. 5.

Removal of the Exposed Patterned Low-k Dielectric Material Layer 30—FIG. 6

As shown in FIG. 6, using the second patterned mask layer 70 as a mask, the exposed portions of patterned low-k dielectric material layer 30 between the metal vertical electrode plate structures 16, 18, 20, 22, 24, 26 are removed, preferably by etching, to form openings/trenches 72, 74, 76, 78, 80 between the metal vertical electrode plate structures 16, 18, 20, 22, 24, 26.

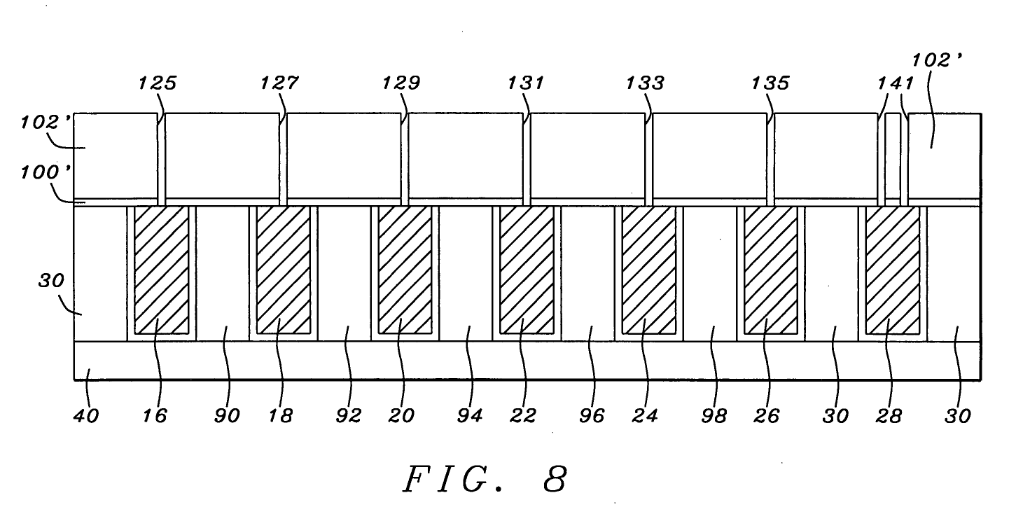

Formation of High-k Dielectric Material Portions 90 92, 94 96, 98—FIG. 7

As shown in FIG. 7, second patterned mask layer 70 is removed and the structure is cleaned as necessary.

Openings/trenches 72, 74, 76, 78, 80 between the metal vertical electrode plate structures 16, 18, 20, 22, 24, 26 are filled with a high-k dielectric material to form respective high-k dielectric material portions 90, 92, 94, 96, 98 between the metal vertical electrode plate structures 16, 18, 20, 22, 24, 26. The high-k dielectric material portions 90, 92, 94, 96, 98 are preferably comprised of SiN, Taₓ,O_{y}, Hfₓ,O_{y}, Tiₓ,O_{y}, Al₂O₃, TaₓAl_{y}O_{z}, Tiₓ,Al_{y}O_{z}, SiO₂, Taₓ,N_{y}O_{z}, Tiₓ,N_{y}O_{z} or other non-conductive oxidized refractory metals and is more preferably a low leakage and high breakdown material.

The high-k dielectric material portions 90, 92, 94, 96, 98 are comprised of a material having a dielectric constant of preferably greater than about 3.0 and more preferably from about 7.0 to 50.0.

Formation of Optional Etch Stop Layer 100—FIG. 7

As shown in FIG. 7, an optional etch stop layer 100 is then formed over the metal vertical electrode plate structures 16, 18, 20, 22, 24, 26, the high-k dielectric material portions 90, 92, 94, 96, 98 therebetween and the remaining low-k dielectric material 30 as shown in FIG. 7. Optional etch stop layer 100 has a thickness of preferably from about 100 to 1000 Å and more preferably from about 300 to 600 Å, and is preferably comprised of SiN or SiₓO_{y}N_{z} and is more preferably SiN.

Formation of Upper Low-k Dielectric Material Layer 102—FIG. 7

Then, as shown in FIG. 7, an upper low-k dielectric material layer 102 may be formed over the optional etch stop layer 100 (or over the metal vertical electrode plate structures 16, 18, 20, 22, 24, 26, the high-k dielectric material portions 90, 92, 94, 96, 98 therebetween and the remaining low-k dielectric material 30 if the optional etch stop layer 100 is not used) to a thickness of preferably from about 2000 to 50,000 Å and more preferably form about 5000 to 10,000 Å. The upper low-k dielectric material layer 102 is preferably comprised of TEOS, FTEOS, Coral™, Black Diamond™ or an organic material. The upper low-k layer 102 may be comprised of the same material as the low-k layer/layer portions 30 and it is preferred that the low-k layers 30 and 102 be comprised of the same material.

A third patterned mask layer 104 is then formed over the upper low-k layer 102 with respective openings 105, 107, 109, 111, 113, 115 positioned over at least a portion of the respective metal vertical electrode plate structures 16, 18, 20, 22, 24, 26 and exposing respective portions of the upper low-k layer 102. Third patterned mask layer 104 may also include an opening or openings 121 positioned over at least a portion of the metal trench structure 28 adjacent the MIM capacitor 10 and exposing respective portion(s) of the upper low-k layer 102.

Formation of Via Openings 125, 127, 129, 131, 133, 135, 141—FIG. 8

As shown in FIG. 8, the upper low-k dielectric layer 102 is patterned to form respective via openings 125, 127, 129, 131, 133, 135, 141 exposing respective portions of the vertical electrode plate structures 16, 18, 20, 22, 24, 26 and metal trench structure 28. If optional etch stop layer 100 is used, the patterning of the upper low-k dielectric layer 102 exposes portions of the etch stop layer 100 and then the etch stop layer 102 is patterned to expose the respective portions of the vertical electrode plate structures 16, 18, 20, 22, 24, 26 and metal trench structure 28.

Formation of Via Structures 146 148 150 152 154, 156 And Metal Via Structure 162—FIG. 9

Via openings 125, 127, 129, 131, 133, 135, 141 may then be lined with respective via barrier layers (not shown) and then filled with respective via structures 146, 148, 150, 152, 154, 156 and metal via structure 162.

The via barrier layers are preferably comprised of Ta or TaN.

The via structures 146, 148, 150, 152, 154, 156 and metal via structure 162 are preferably comprised of copper (Cu) or tungsten (W) and are more preferably copper (Cu).

Advantages of the Invention

The advantages of one or more embodiments of the present invention include:
1) there is no sharp corners at the trench bottom leading to poor breakdown;
2) no metal etch is required so no cleaning step for a metal etch is required;
3) no topology induced due to the MIM capacitor so no oxide CMP is needed;
4) great flexibility to choices of low-k and high-k materials as there is no concern of Cu oxidation due to the high or low-k oxide material definition; and
5) simple process and structural design.

While particular embodiments of the present invention have been illustrated and described, it is not intended to limit the invention, except as defined by the following claims.

1. A method of forming a capacitor, comprising the steps of:
providing a substrate having a lower low-k dielectric layer formed thereover; the lower low-k dielectric layer having a dielectric constant of less than about 3.0;
forming metal vertical electrode plates within the lower low-k dielectric layer such that adjacent metal vertical electrode plates have lower low-k dielectric layer portions therebetween; and
replacing the lower low-k dielectric layer portions between the adjacent metal vertical electrode plates with high-k dielectric material trench portions; the high-k dielectric material trench portions having a dielectric constant of greater than about 3.0.

2. The method of claim 1, wherein the substrate is a semiconductor wafer.

3. The method of claim 1, wherein the lower low-k dielectric layer has a thickness of from about 2000 to 50,000 Å.

4. The method of claim 1, wherein the lower low-k dielectric layer has a thickness of from about 5000 to 10,000 Å.

5. The method of claim 1, wherein the lower low-k dielectric layer is comprised of TEOS, FTEOS, Coral™, Black Diamond™ or an organic material.

6. The method of claim 1, wherein the lower low-k dielectric layer is comprised of an organic material.

7. The method of claim 1, wherein the high-k dielectric material trench portions are comprised of SiN, TaₓO_{y}, HfₓO_{y}, TiₓO_{y}, Al₂O₃, TaₓAl_{y}O_{z}, Tiₓ,Al_{y}O_{z}, SiO₂, TaₓN_{y}O_{z}, TiₓN_{y}O_{z} or a non-conductive oxidized refractory metal.

8. The method of claim 1, wherein the high-k dielectric material trench portions are comprised of a low leakage and high breakdown material.

9. The method of claim 1, wherein the high-k dielectric material trench portions have a dielectric constant of from about 7.0 to 50.0.

10. The method of claim 1, wherein the metal vertical electrode plates are comprised of copper or tungsten.

11. The method of claim 1, wherein the metal vertical electrode plates are comprised of copper.

12. The method of claim 1, including the step of lining the metal vertical electrode plates with respective metal barrier layers.

13. The method of claim 1, including the step of lining the metal vertical electrode plates with respective metal barrier layers comprised of Ta or TaN.

14. The method of claim 1, including the step of lining the metal vertical electrode plates with respective metal barrier layers comprised of Ta/TaN.

15. The method of claim 1, including the steps of:
forming an upper low-k dielectric material layer over the metal vertical electrode plates; the upper low-k dielectric material layer having a dielectric constant of less than about 3.0; and
forming respective via structures within the upper low-k dielectric material layer in electrical communication with the respective metal vertical electrode plates.

16. The method of claim 1, including the steps of:
forming an upper low-k dielectric material layer over the metal vertical electrode plates; the upper low-k dielectric material layer having a dielectric constant of less than about 3.0; and
forming respective lined via structures within the upper low-k dielectric material layer in electrical communication with the respective metal vertical electrode plates.

17. The method of claim 1, including the steps of:
forming an upper low-k dielectric material layer over the metal vertical electrode plates to a thickness of from about 2000 to 50,000 Å; the upper low-k dielectric material layer having a dielectric constant of less than about 3.0; and
forming respective via structures within the upper low-k dielectric material layer in electrical communication with the respective metal vertical electrode plates; the via structures being comprised of copper or tungsten.

18. The method of claim 1, including the steps of:
forming an upper low-k dielectric material layer over the metal vertical electrode plates to a thickness of from about 5000 to 10,000 Å; the upper low-k dielectric material layer having a dielectric constant of less than about 3.0; and
forming respective via structures within the upper low-k dielectric material layer in electrical communication with the respective metal vertical electrode plates; the via structures being comprised of copper.

19. The method of claim 1, including the steps of:
forming an etch stop layer over the metal vertical electrode plates;
forming an upper low-k dielectric material layer over the etch stop layer; the upper low-k dielectric material layer having a dielectric constant of less than about 3.0; and
forming respective via structures within the etch stop layer and the upper low-k dielectric material layer in electrical communication with the respective metal vertical electrode plates.

20. The method of claim 1, including the steps of:
forming an etch stop layer over the metal vertical electrode plates to a thickness of from about 100 to 1000 Å; the etch stop layer 100 being formed of SiN or SiₓO_{y}N_{z};
forming an upper low-k dielectric material layer over the etch stop layer; the upper low-k dielectric material layer having a dielectric constant of less than about 3.0; and
forming respective via structures within the etch stop layer and the upper low-k dielectric material layer in electrical communication with the respective metal vertical electrode plates.

21. The method of claim 1, including the steps of:
forming an etch stop layer over the metal vertical electrode plates to a thickness of from about 300 to 600 Å; the etch stop layer being formed of SiN;
forming an upper low-k dielectric material layer over the etch stop layer; the upper low-k dielectric material layer having a dielectric constant of less than about 3.0; and
forming respective via structures within the etch stop layer and the upper low-k dielectric material layer in electrical communication with the respective metal vertical electrode plates.

22. A method of forming a capacitor, comprising the steps of:
providing a substrate having a lower low-k dielectric layer formed thereover; the lower low-k dielectric layer having a dielectric constant of less than about 3.0;
forming copper vertical electrode plates within the lower low-k dielectric layer such that adjacent copper vertical electrode plates have lower low-k dielectric layer portions therebetween; and
replacing the lower low-k dielectric layer portions between the adjacent copper vertical electrode plates with high-k dielectric material trench portions; the high-k dielectric material trench portions having a dielectric constant of greater than about 3.0.

23. The method of claim 22, wherein the lower low-k dielectric layer has a thickness of from about 2000 to 50,000 Å.

24. The method of claim 22, wherein the lower low-k dielectric layer has a thickness of from about 5000 to 10,000 Å.

25. The method of claim 22, wherein the lower low-k dielectric layer is comprised of TEOS, FTEOS, Coral™, Black Diamond™ or an organic material.

26. The method of claim 22, wherein the lower low-k dielectric layer is comprised of an organic material.

27. The method of claim 22, wherein the high-k dielectric material trench portions are comprised of SiN, TaₓO_{y}, HfₓO_{y}, TiₓO_{y}, Al₂O₃, TaₓAl_{y}O_{z}, TiₓAl_{y}O_{z}, SiO₂, TaₓN_{y}O_{z}, TiₓN_{y}O_{z} or a non-conductive oxidized refractory metal.

28. The method of claim 22, wherein the high-k dielectric material trench portions are comprised of a low leakage and high breakdown material.

29. The method of claim 22, wherein the high-k dielectric material trench portions have a dielectric constant of from about 7.0 to 50.0.

30. The method of claim 22, including the step of lining the copper vertical electrode plates with respective metal barrier layers.

31. The method of claim 22, including the step of lining the copper vertical electrode plates with respective metal barrier layers comprised of Ta or TaN.

32. The method of claim 22, including the step of lining the copper vertical electrode plates with respective metal barrier layers comprised of Ta/TaN.

33. The method of claim 22, including the steps of:
forming an upper low-k dielectric material layer over the copper vertical electrode plates; the upper low-k dielectric material layer having a dielectric constant of less than about 3.0; and
forming respective via structures within the upper low-k dielectric material layer in electrical communication with the respective copper vertical electrode plates.

34. The method of claim 22, including the steps of:
forming an upper low-k dielectric material layer over the copper vertical electrode plates; the upper low-k dielectric material layer having a dielectric constant of less than about 3.0; and
forming respective lined via structures within the upper low-k dielectric material layer in electrical communication with the respective copper vertical electrode plates.

35. The method of claim 22, including the steps of:
forming an upper low-k dielectric material layer over the copper vertical electrode plates to a thickness of from about 2000 to 50,000 Å; the upper low-k dielectric material layer having a dielectric constant of less than about 3.0; and
forming respective via structures within the upper low-k dielectric material layer in electrical communication with the respective copper vertical electrode plates; the via structures being comprised of copper or tungsten.

36. The method of claim 22, including the steps of:
forming an upper low-k dielectric material layer over the copper vertical electrode plates to a thickness of from about 5000 to 10,000 Å; the upper low-k dielectric material layer having a dielectric constant of less than about 3.0; and
forming respective via structures within the upper low-k dielectric material layer in electrical communication with the respective copper vertical electrode plates; the via structures being comprised of copper.

37. The method of claim 22, including the steps of:
forming an etch stop layer over the copper vertical electrode plates;
forming an upper low-k dielectric material layer over the etch stop layer; the upper low-k dielectric material layer having a dielectric constant of less than about 3.0; and
forming respective via structures within the etch stop layer and the upper low-k dielectric material layer in electrical communication with the respective copper vertical electrode plates.

38. The method of claim 22, including the steps of:
forming an etch stop layer over the copper vertical electrode plates to a thickness of from about 100 to 1000 Å; the etch stop layer 100 being formed of SiN or SiₓO_{y}N_{z};
forming an upper low-k dielectric material layer over the etch stop layer; the upper low-k dielectric material layer having a dielectric constant of less than about 3.0; and
forming respective via structures within the etch stop layer and the upper low-k dielectric material layer in electrical communication with the respective copper vertical electrode plates.

39. The method of claim 22, including the steps of:
forming an etch stop layer over the copper vertical electrode plates to a thickness of from about 300 to 600 Å; the etch stop layer being formed of SiN;
forming an upper low-k dielectric material layer over the etch stop layer; the upper low-k dielectric material layer having a dielectric constant of less than about 3.0; and
forming respective via structures within the etch stop layer and the upper low-k dielectric material layer in electrical communication with the respective copper vertical electrode plates.

40. A method of forming a capacitor, comprising the steps of:
providing a semiconductor wafer having a lower low-k dielectric layer formed thereover; the lower low-k dielectric layer having a dielectric constant of less than about 3.0 and a thickness of from about 2000 to 50,000 Å;
forming metal vertical electrode plates within the lower low-k dielectric layer such that adjacent metal vertical electrode plates have lower low-k dielectric layer portions therebetween; the metal vertical electrode plates being comprised of copper or tungsten; and
replacing the lower low-k dielectric layer portions between the adjacent metal vertical electrode plates with high-k dielectric material trench portions; the high-k dielectric material trench portions having a dielectric constant of greater than about 3.0 and are comprised of a non-conductive oxidized refractory metal.

41. The method of claim 40, wherein the lower low-k dielectric layer has a thickness of from about 5000 to 10,000 Å.

42. The method of claim 40, wherein the lower low-k dielectric layer is comprised of TEOS, FTEOS, Coral™, Black Diamond® or an organic material.

43. The method of claim 40, wherein the lower low-k dielectric layer is comprised of an organic material.

44. The method of claim 40, wherein the high-k dielectric material trench portions are comprised of SiN, Taₓ,O_{y}, HfₓO_{y}, TiₓO_{y}, Al₂O₃, TaₓAl_{y}O_{z}, TiₓAl_{y}O_{z}, SiO₂, TaₓN_{y}O_{z} or TiₓN_{y}O_{z}.

45. The method of claim 40, wherein the high-k dielectric material trench portions have a dielectric constant of from about 7.0 to 50.0.

46. The method of claim 40, wherein the metal vertical electrode plates are comprised of copper.

47. The method of claim 40, including the step of lining the metal vertical electrode plates with respective metal barrier layers.

48. The method of claim 40, including the step of lining the metal vertical electrode plates with respective metal barrier layers comprised of Ta or TaN.

49. The method of claim 40, including the step of lining the metal vertical electrode plates with respective metal barrier layers comprised of Ta/TaN.

50. The method of claim 40, including the steps of:
forming an upper low-k dielectric material layer over the metal vertical electrode plates; the upper low-k dielectric material layer having a dielectric constant of less than about 3.0; and
forming respective via structures within the upper low-k dielectric material layer in electrical communication with the respective metal vertical electrode plates.

51. The method of claim 40, including the steps of:
forming an upper low-k dielectric material layer over the metal vertical electrode plates; the upper low-k dielectric material layer having a dielectric constant of less than about 3.0; and
forming respective lined via structures within the upper low-k dielectric material layer in electrical communication with the respective metal vertical electrode plates.

52. The method of claim 40, including the steps of:
forming an upper low-k dielectric material layer over the metal vertical electrode plates to a thickness of from about 2000 to 50,000 Å; the upper low-k dielectric material layer having a dielectric constant of less than about 3.0; and
forming respective via structures within the upper low-k dielectric material layer in electrical communication with the respective metal vertical electrode plates; the via structures being comprised of copper or tungsten.

53. The method of claim 40, including the steps of:
forming an upper low-k dielectric material layer over the metal vertical electrode plates to a thickness of from about 5000 to 10,000 Å; the upper low-k dielectric material layer having a dielectric constant of less than about 3.0; and
forming respective via structures within the upper low-k dielectric material layer in electrical communication with the respective metal vertical electrode plates; the via structures being comprised of copper.

54. The method of claim 40, including the steps of:
forming an etch stop layer over the metal vertical electrode plates;
forming an upper low-k dielectric material layer over the etch stop layer; the upper low-k dielectric material layer having a dielectric constant of less than about 3.0; and
forming respective via structures within the etch stop layer and the upper low-k dielectric material layer in electrical communication with the respective metal vertical electrode plates.

55. The method of claim 40, including the steps of:
forming an etch stop layer over the metal vertical electrode plates to a thickness of from about 100 to 1000 Å; the etch stop layer 100 being formed of SiN or SiₓO_{y}N_{z};
forming an upper low-k dielectric material layer over the etch stop layer; the upper low-k dielectric material layer having a dielectric constant of less than about 3.0; and
forming respective via structures within the etch stop layer and the upper low-k dielectric material layer in electrical communication with the respective metal vertical electrode plates.

56. The method of claim 40, including the steps of:
forming an etch stop layer over the metal vertical electrode plates to a thickness of from about 300 to 600 Å; the etch stop layer being formed of SiN;
forming an upper low-k dielectric material layer over the etch stop layer; the upper low-k dielectric material layer having a dielectric constant of less than about 3.0; and
forming respective via structures within the etch stop layer and the upper low-k dielectric material layer in electrical communication with the respective metal vertical electrode plates.
